(19) United States
(12) Patent Application Publication
(10) Pub. No.: US 2009/0162724 A1
(43) Pub. Date: Jun. 25, 2009

(54) ION CONDUCTING COPOLYMERS WITH ELASTOMERIC AND POLYARYLENE SEGMENTS

(75) Inventor: David Olmeijer, San Francisco, CA (US)

Correspondence Address: MORGAN, LEWIS & BOCKIUS, LLP, ONE MARKET SPEAR STREET TOWER, SAN FRANCISCO, CA, 94105, US

(73) Assignee: Polyfuel, Inc, Mountain View, CA (US)

(21) Appl. No.: 12/338,222

(22) Filed: Dec. 18, 2008

Related U.S. Application Data
(60) Provisional application No. 61/014,564, filed on Dec. 18, 2007.

(51) Int. Cl. H01M 8/10; B01J 39/18; B01J 39/20

(52) U.S. Cl. 429/33; 521/25; 521/38

(57) ABSTRACT

Ion conducting polymers containing polyarylene ion conducting segments and elastomeric segments covalently linked to each other are used to make polymer electrolyte membranes that can be used in fuel cells such as direct methanol fuel cells.

### FIELD OF THE INVENTION

The invention encompasses ion conductive polymers, which are useful in forming polymer electrolyte membranes used in fuel cells. More specifically, the invention encompasses copolymers comprising at least one non-ionic elastomeric segment and at least one ionic arylene segment.

### BACKGROUND OF THE INVENTION

Fuel cells have been projected as promising power sources for portable electronic devices, electric vehicles, and other applications due mainly to their non-polluting nature. Of various fuel cell systems, the polymer electrolyte membrane based fuel cell technology such as direct methanol fuel cells (DMFCs) have attracted much interest thanks to their high power density and high energy conversion efficiency. The “heart” of a polymer electrolyte membrane based fuel cell is the so called “membrane-electrode assembly” (MEA), which comprises a proton conducting polymer electrolyte membrane (PEM), catalyst disposed on the opposite surfaces of the PEM to form a catalyst coated membrane (CCM) and a pair of electrodes (i.e., an anode and a cathode) disposed to be in electrical contact with the catalyst layer.

The need for a good membrane for fuel cell operation requires balancing of various properties of the membrane. Such properties included proton conductivity, methanol-resistance, chemical stability and methanol crossover especially for high temperature applications, fast start up of DMFCs, and durability of cell performance. In addition, it is important for the membrane to retain its dimensional stability over the fuel operational temperature range. In the case of a DMFC, methanol oxidation generates enough heat to raise the cell temperature. If the membrane swells significantly, it will increase methanol crossover. The membrane thus gradually loses its ability to block methanol crossover, resulting in degradation of cell performance. The dimension changes of the membrane also put a stress on the bonding of the membrane-electrode assembly (MEA). Often this results in delamination of the membrane from the electrode after excessive swelling of the membrane. This can also result in delamination of the catalyst layer. Therefore, maintaining the dimensional stability over a wide temperature range and avoiding excessive membrane swelling are important for DMFC applications.

Thus, there is a need for novel polymeric materials to increase the efficiency, properties, and sustainability of conventional fuel cells.

### SUMMARY OF THE INVENTION

The invention broadly encompasses ion conductive copolymer compositions with elastomeric segments and ion-conducting polyarylene segments, which can be used to fabricate polymer electrolyte membranes (PEM's), catalyst coated polymer electrolyte membranes (CCM's) and membrane electrode assemblies (MEA's), which are useful in fuel cells. Such compositions and components containing them are sometimes referred to herein as aryl/elastomeric ion-conducting composition, aryl/elastomeric ion-conducting PEM's, etc.

In one embodiment, the invention encompasses a polymer with a multiblock architecture. In certain embodiments, one block segment includes an amino-terminated sulfonated arylene oligomer, which is copolymerized with an acyl chloride or a carboxyl-terminated elastomeric oligomer. In certain embodiments, the elastomeric oligomer is composed of butadiene, but this could extend to copolymers of, for example, butadiene, styrene, acrylonitrile, butylene and ethylene. In other illustrative embodiments, the amino-terminated sulfonated oligomer, is derived from the oligomerization of benzophenone and cyclohexylidene bisphenol monomers.

In another embodiment, the copolymerization of the two different oligomers results in a new polymer, which can be used either as a new proton exchange membrane or, more preferably, as an adhesion promotion layer on the same or different polymer electrolyte membrane.

In certain illustrative embodiments, the ion conductive block copolymer comprises one or more non-ionic elastomeric polymers and one or more ionic polymers covalently linked either directly or indirectly to each other. In another illustrative embodiment, the ion conductive block copolymer comprises one or more non-ionic elastomeric polymers and one or more ionic arylene polymers covalently linked either directly or indirectly to each other. In some embodiments at least one of the ionic arylene polymers or non-ionic elastomeric polymers is a block polymer in the ion conductive copolymer. In other embodiments, both the ionic arylene polymers and the non-ionic elastomeric polymers are block polymers. The elastomeric non-ionic polymer comprises at least one non-ionic monomer. The ionic polymer comprises at least one aryl monomer and an ion conducting group such as, for example, a sulfonic acid moiety.

The ionic monomers can be reacted to produce ionic blocks while non-ionic monomers can be reacted separately to produce non-ionic blocks, which can thereafter be combined. The variability of the components of the ion conducting block copolymer provide for the formation of a variety of ion conducting block copolymers. Mixing and matching of these different ionic and non-ionic polymers provides for the formation of the ion conducting block copolymers of the invention.

By adjusting the block size, the overall molecular length, the rigidity and the affinity among the ion conducting copolymers, it is possible to control ion channel size distributions and affinity as well fuel cross-over, stability, solubility and mechanical properties of the ion conductive polymer and the membranes made therefrom.

### BRIEF DESCRIPTION OF THE DRAWINGS

FIG. 1 illustrates an adhesion promotion layer comprising an aryl/elastomeric ion conducting polymer, wherein the polymer is coated onto a film of a polymer electrolyte membrane by a rod-coating process using a standard #6 rod to produce a membrane containing an adhesion promotion layer.

### DETAILED DESCRIPTION OF INVENTION

### Definitions

As used herein and unless otherwise indicated, the term “acyl” refers to an organic acid group in which the OH of the carboxyl group is replaced by some other substituent (RCO—). Examples include, but are not limited to, halo, acetyl and benzoyl.

As used herein and unless otherwise indicated, the term “alkoxy group” means an —O-alkyl group, wherein alkyl is as defined herein. An alkoxy group can be unsubstituted or substituted with one or two suitable substituents. Preferably, the alkyl chain of an alkyloxy group is from 1 to 6 carbon atoms in length, referred to herein, for example, as “(C1-C6)alkoxy.”

As used herein and unless otherwise indicated, the term “alkenyl group” means a monovalent unbranched or branched hydrocarbon chain having one or more double bonds therein. The double bond of an alkenyl group can be unconjugated or conjugated to another unsaturated group. Suitable alkenyl groups include, but are not limited to (C2-C6)alkenyl groups, such as vinyl, allyl, butenyl, pentenyl, hexenyl, butadienyl, pentadienyl, hexadienyl, 2-ethylhexenyl, 2-propyl-2-butenyl, 4-(2-methyl-3-butene)-pentenyl. An alkenyl group can be unsubstituted or substituted with one or two suitable substituents.

As used herein and unless otherwise indicated, the term “alkyl” or “alkyl group” means a saturated, monovalent unbranched or branched hydrocarbon chain. Examples of alkyl groups include, but are not limited to, (C1-C6)alkyl groups, such as methyl, ethyl, propyl, isopropyl, 2-methyl-1-propyl, 2-methyl-2-propyl, 2-methyl-1-butyl, 3-methyl-1-butyl, 2-methyl-3-butyl, 2,2-dimethyl-1-propyl, 2-methyl-1-pentyl, 3-methyl-1-pentyl, 4-methyl-1-pentyl, 2-methyl-2-pentyl, 3-methyl-2-pentyl, 4-methyl-2-pentyl, 2,2-dimethyl-1-butyl, 3,3-dimethyl-1-butyl, 2-ethyl-1-butyl, butyl, isobutyl, t-butyl, pentyl, isopentyl, neopentyl, and hexyl, and longer alkyl groups, such as heptyl, and octyl. An alkyl group can be unsubstituted or substituted with one or two suitable substituents.

As used herein and unless otherwise indicated, the term “amido” refers to the group of composition R¹CON(R²)— where R¹ and R² are H or some alkyl, aryl, cycloalkyl, perfluoroalkyl, or perfluoroaryl group. Examples include, but are not limited to acetamido, N-ethylbenzamido, etc.

As used herein and unless otherwise indicated, the term “aryl group” or “aromatic moiety” means a monocyclic or polycyclic-aromatic radical comprising carbon and hydrogen atoms. Examples of suitable aryl groups include, but are not limited to, phenyl, tolyl, anthacenyl, fluorenyl, indenyl, azulenyl, and naphthyl, as well as benzo-fused carbocyclic moieties such as 5,6,7,8-tetrahydronaphthyl. An aryl group can be unsubstituted or substituted with up to four suitable substituents. Preferably, the aryl group is a monocyclic ring, wherein the ring comprises 6 carbon atoms, referred to herein as “(C6)aryl.”

As used herein and unless indicated otherwise, an “arylene” segment or block refers to a polymeric segment or block that contains an aryl group or aromatic moiety.

As used herein and unless otherwise indicated, the term “aryloxy group” means an —O-aryl group, wherein aryl is as defined herein. An aryloxy group can be unsubstituted or substituted with one or two suitable substituents. Preferably, the aryl ring of an aryloxy group is a monocyclic ring, wherein the ring comprises 6 carbon atoms, referred to herein as “(C6)aryloxy.”

As used herein and unless otherwise indicated, the term “benzyl” means —CH₂-phenyl.

As used herein and unless otherwise indicated, the term “carbonyl” group is a divalent group of the formula —C(O)—.

As used herein and unless otherwise indicated, the term “carbamoyl” refers to the group of composition R¹(R²)NC(O)— where R¹ and R² are H or some alkyl, aryl, cycloalkyl, perfluoroalkyl, or perfluoroaryl group. Examples include, but are not limited to N-ethylcarbamoyl, N,N-dimethylcarbamoyl, etc.

As used herein and unless otherwise indicated, the term “cyano” refers to the —CN group.

As used herein and unless otherwise indicated, an “elastomeric” segment or block is a polymeric segment or block containing elastomeric monomers such as butadiene, isoprene, styrene, acrylonitrile, ethelene monomers, etc., and mixtures thereof.

As used herein and unless otherwise indicated, the term “halogen” or “halo” refers to one of the electronegative elements of group VIIA of the periodic table (fluorine, chlorine, bromine, iodine, and astatine).

As used herein and unless otherwise indicated, the term “linker” or “linking moiety” is a molecule used to couple two different molecules, two subunits of a molecule, or a molecule to a substrate.

As used herein and unless otherwise indicated, a metal is designated by “M” or “Mⁿ,” where n is an integer, it is recognized that the metal may be associated with a counter ion.

As used herein and unless otherwise indicated, the term “multiple oxidation states” means more than one oxidation state. In preferred embodiments, the oxidation states may reflect the gain of electrons (reduction) or the loss of electrons (oxidation).

As used herein and unless otherwise indicated, the term “substituent” or “substituted” as used in the formulas herein. Preferred substituents include, but are not limited to, aryl, phenyl, cycloalkyl, alkyl, halogen, alkoxy, alkylthio, perfluoroalkyl, perfluoroaryl, pyridyl, cyano, thiocyanato, nitro, amino, alkylamino, acyl, sulfoxyl, sulfonyl, amido, and carbamoyl. In preferred embodiments, a substituted aryl group is attached to a porphyrin or a porphyrinic macrocycle, and the substituents on the aryl group are selected from the group consisting of aryl, phenyl, cycloalkyl, alkyl, halogen, alkoxy, alkylthio, perfluoroalkyl, perfluoroaryl, pyridyl, cyano, thiocyanato, nitro, amino, alkylamino, acyl, sulfoxyl, sulfonyl, amido, and carbamoyl. Additional substituents include, but are not limited to, 4-chlorophenyl, 4-trifluoromethylphenyl, and 4-methoxyphenyl. Preferred substituents provide a redox potential range of less than about 5 volts, preferably less than about 2 volts, more preferably less than about 1 volt. Many of the compounds described herein utilize substituents, generally depicted herein as “R.” Suitable R groups include, but are not limited to, hydrogen, alkyl, alcohol, aryl, amino, amido, nitro, ethers, esters, aldehydes, sulfonyl, silicon moieties, halogens, cyano, acyl, sulfur containing moieties, phosphorus containing moieties, amido, imido, carbamoyl, linkers, attachment moieties and other subunits. In a particularly preferred embodiment at least one substituent is a sulfoxyl or sulfonyl group.

As used herein and unless otherwise indicated, the term “sulfoxyl” refers to a group of composition RS(O)— where R is some alkyl, aryl, cycloalkyl, perfluoroalkyl, or perfluoroaryl group. Examples include, but are not limited to methylsulfoxyl, phenylsulfoxyl.

As used herein and unless otherwise indicated, the term “sulfonyl” refers to a group of composition RSO₂, where R is some alkyl, aryl, cycloalkyl, perfluoroalkyl, or perfluoroaryl group. Examples include, but are not limited to methylsulfonyl, phenylsulfonyl, p-toluenesulfonyl.

As used herein and unless otherwise indicated, the term “thiocyanato” refers to the —SCN group.

### GENERAL DESCRIPTION OF THE INVENTION

The present invention generally encompasses ion conductive polymers, which are useful in forming membranes, preferably polymer electrolyte membranes (PEM's), catalyst coated polymer electrolyte membranes (CCM's) and membrane electrode assemblies (MEA's) used, for example, in fuel cells and as a component or the component of an adhesion promotion layer between the membrane and catalyst layer as disclosed in US Patent Publication 2006/0068268 entitled Membrane and Membrane Electrode Assembly with Adhesion Promotion Layer. The invention further encompasses multiblock copolymers comprising at least one non-ionic segment and at least one ionic segment and methods of manufacture and use thereof. Specifically, the invention encompasses multiblock copolymers comprising at least one non-ionic elastomeric segment and at least one ionic arylene segment.

In an illustrative embodiment, the invention encompasses an ionic conducting copolymer including at least one ionic conducting arylene segment comprising an ionic conducting group and at least one non-ionic conducting elastomeric segment.

The ion conducting polymer can be represented by Formula I:

-[(E)ₑ-L₁-ICS-L₂-]ₖ-

where [(E)ₑ] is an elastomeric segment, E is an elastomeric unit, e is the number of elastomeric units in the elastomeric segment, L₁ is a bond or a linking group, ICS is an ion conducting segment and L₂ is a bond or a linking group which can be the same or different than L₁, and k is the number of times the overall unit is repeated.
L₁ and L₂ can comprise amide (—C(O)—NH—), ester (—C(O)—O—), imide (—C(O)—NH—C(O)—), urethane (—NH—C(O)—O—), carbonate (—O—C(O)—O—), ether (—O—), sulfide (—S—)ketone (—C(O)—), sulfone (—S(O)₂—) and sulfonamide (—S(O)₂—NH—) linkages. They can also comprise aryl or alkyl components.

In a particular illustrative embodiment, the elastomeric segment comprises a styrene/butadiene/styrene block copolymer (SBS), styrene/isoprene block/styrene block copolymer (SIS), random styrene/butadiene copolymers (random SBR), tapered SBR, microblock SBR, random styrene/isoprene copolymer (random SIR), tapered SIR, random styrene/butadiene/isoprene (random SIBR), styrene-ethylene/butylene-styrene block copolymer (SEBS), styrene-ethylene/butylene block copolymer (SEB), styrene-ethylene/propylene-block copolymer (SEP), styrene-ethylene/propylene-styrene block copolymer (SEPS), styrene-ethylene/propylene-ethylene block copolymer (SEPE), styrene-ethylene/butylene-ethylene block copolymer (SEBE), styrene-ethylene/styrene block copolymer (SES), ethylene-ethylene/butylene block copolymer (EEB), ethylene-ethylene/butylene/styrene block copolymer (hydrogenated BR-SBR block copolymer), ethylene-ethylene/butylene/styrene-ethylene block copolymer (hydrogenated BR-SBR-BR block copolymer), ethylene-ethylene/butylene-ethylene block copolymer (EEBE) and partially or fully hydrogenated versions of these polymers and copolymers.

In a particular embodiment, the elastomeric segment comprises a butadiene monomer.

When the ICS is an ion conducting arylene segment it can be represented by Formula II:

[[(Ar₁-T-)ᵢ—Ar₁—X—]ₐ^{m}[Ar₂—U—Ar₂—X—]_{b}ⁿ[(Ar₃—V—)ⱼ—Ar₃—X—]_{c}^{o}[Ar₄—W—Ar₄—X—]_{d}^{p} (Formula II)

where [(Ar₁-T-)ᵢ—Ar₁—X—]ₐ^{m} is an ion conducting oligomer, [Ar₂—U—Ar₂—X—]_{b}ⁿ is an ion condcucting comonomer, [(Ar₃—V—)ⱼ—Ar₃—X—]_{c}^{o} is a non-ionic oligomer and [Ar₄—W—Ar₄—X—]_{d}^{p} is a non-ionic comonomer
wherein Ar₁, Ar₂, Ar₃ and Ar₄ are aromatic moieties and at least one of Ar₁ or Ar₂ comprises an ion conducting group;
wherein: T, U, V and W are linking moieties;
each X is independently —O— or —S—;
i and j are independently integers equal to or greater than 1;
a, b, c, and d are mole fractions wherein the sum of a, b, c and d is 1, and a and/or b is greater than zero; and
m, n, o, and p are integers indicating the number of different oligomers or monomers in the copolymer.

The mole percent of ion-conducting groups when two ion-conducting group is present in a comonomer is preferably between 20 and 70%, or more preferably between 25 and 60%, and most preferably between 30 and 50%. When more than one conducting group is contained within the ion-conducting monomer, such percentages are multiplied by the total number of ion-conducting groups per monomer. Thus, in the case of a monomer comprising two sulfonic acid groups, the preferred sulfonation is 40 to 140%, more preferably 50 to 120% and most preferably 60 to 100%. Alternatively, the amount of ion-conducting group can be measured by the ion exchange capacity (IEC). By way of comparison, Nafion® typically has a ion exchange capacity of 0.9 meq per gram. In the present invention, it is preferred that the IEC be between 0.7 and 3.0 meq per gram, more preferably between 0.8 and 2.5 meq per gram, and most preferably between 1.0 and 2.0 meq per gram.

In some embodiments, Ar₁, Ar₂, Ar₃ and Ar₄ are independently phenyl, substituted phenyl, napthyl, terphenyl, aryl nitrile and substituted aryl nitrile.

In some embodiments T, U, V and W are independently a bond, —O—, —S—, —C(O)—, —S(O)₂—,

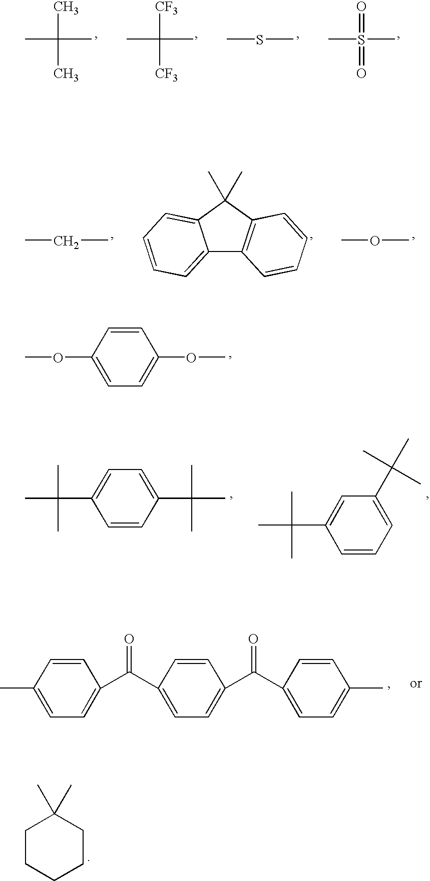

In other embodiments, T, U, V and W are independently a bond O, S, C(O), S(O₂), alkyl branched alkyl fluoroalkyl, branched fluoroalkyl, cycloalkyl, aryl, substituted aryl or heterocycle

In other embodiments, a is at least 0.3 and at least one of b, c and d are greater than 0.

In an illustrative embodiments, at least two of b, c and d are greater than 0. In some embodiments, c and d are greater than 0. In other embodiments, b and d are greater than 0. In still another embodiment, b and c are greater than 0. In other embodiments each of b, c and d are greater than 0.

In the case of a random ion conducting copolymer the above formula can be represented as Formula III:

[Ar₂—U—Ar₂—X—]_{b}ⁿ[Ar₄—W—Ar₄—X—]_{d}^{p}

where [Ar₂—U—Ar₂—X—]_{b}ⁿ is an ion conducting comonomer, [Ar₄—W—Ar₄—X—]_{d}^{p} is a non-ionic comonomer and the sum of b and d is 1.

In another embodiment, the ion conducting group comprises a sulfonic acid.

In another embodiment, at least one of Ar₁, Ar₂, Ar₃ and Ar₄ comprises a benzophenone monomer.

In another embodiment, at least one of Ar₁, Ar₂, Ar₃ and Ar₄ comprises a cyclohexylidene bisphenol monomer.

In another embodiment, at least one benzophenone monomer comprises an ion conducting group.

In another embodiment, at least one benzophenone monomer comprises a sulfonic acid.

In another embodiment, the elastomeric segment comprises butadiene, isoprene, styrene, acrylonitrile, ethylene monomers and mixtures thereof.

In another embodiment, the ion conducting arylene segment and non-ion conducting elastomeric segment are joined by a linking group.

The ionic arylene segments and non-ionic elastomeric segments can alternate or can be joined randomly. In general, the ratio of ionic arylene segments to non-ionic elastomeric segments is chosen so that the resulting polymer has 15-50 weight. % of the elastomeric segment and a total IEC of between 1.0 and 2.0

Another illustrative embodiment encompasses an ion conducting polymer of Formula IV

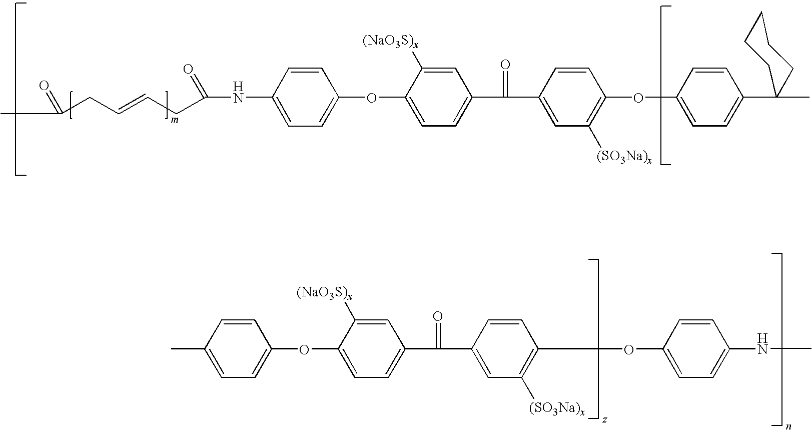

wherein
x is the mole percent of comonomer sulfonation
m is from about 10 to about 500;
z is from about 1 to about 100; and
n is from about 2 to about 5000.

If z is large, n is relatively small. If z is small, then n is relatively large. In some embodiments, the product of z times n is from about 40 to about 5000

In a particular embodiment, m is from about 20 to about 200.

In another particular embodiment, m is from about 50 to about 100.

In another particular embodiment, m is about 70 to about 80.

In another particular embodiment, z is from about 3 to about 100.

In another particular embodiment, z is from about 5 to about 50.

In another particular embodiment, z is about 9 to about 40.

Other ion conducting polymers and copolymers can be used as ion conducting segments in combination with non ion conducting elastomeric segments to form the ion conducting elastomeric polymers of the invention. Examples include the random copolymers disclosed in U.S. patent application Ser. No. 10/438,186, filed May 13, 2003, entitled “Sulfonated Copolymer,” Publication No. US 2004-0039148 A1, published Feb. 26, 2004, and U.S. patent application Ser. No. 10/987,178, filed Nov. 12, 2004, entitled “Ion Conductive Random Copolymer” and the block copolymers disclosed in U.S. patent application Ser. No. 10/438,299, filed May 13, 2003, entitled “Sulfonated Copolymers,” published Jul. 1, 2004, Publication No. 2004-0126666. Other ion conductive copolymers include the oligomeric ion conducting polymers disclosed in U.S. patent application Ser. No. 10/987,951, filed Nov. 12, 2004, entitled “Ion Conductive Copolymers Containing One or More Hydrophobic Monomers or Oligomers,” U.S. patent application Ser. No. 10/988,187, filed Nov. 11, 2004, entitled “Ion Conductive Copolymers Containing First and Second Hydrophobic Oligomers” and U.S. patent application Ser. No. 11/077,994, filed Mar. 11, 2005, entitled “Ion Conductive Copolymers Containing One or More Ion Conducting Oligomers.” All of the foregoing are incorporated herein by reference. Other ion conductive copolymers include U.S. Patent Application No. 60/684,412, filed May 24, 2005, entitled “Ion Conductive Copolymers Containing Ion-Conducting Oligomers,” U.S. Patent Application No. 60/685,300, filed May 27, 2005, entitled “End Capping of Ion-Conductive Copolymers,” U.S. Patent Application No. 60/686,757, filed Jun. 1, 2005, entitled “Cross-Linked Ion-Conductive Copolymers,” U.S. Patent Application No. 60/686,663, filed Jun. 1, 2005, entitled “Polymer Blend Comprising Ion Conductive Polymer and Non-Conductive Polymers,” U.S. Patent Application No. 60/686,755, filed Jun. 1, 2005, entitled “Ion-Conductive Copolymers Containing Pendant Ion Conducting Groups,” and U.S. Patent Application No. 60/687,408, filed Jun. 2, 2005, entitled “Anisotropic Polymer Electrolyte Membranes.”

Other ion-conducting copolymers and the monomers that can be used to make them include those disclosed in U.S. patent application Ser. No. 09/872,770, filed Jun. 1, 2001, Publication No. US 2002-0127454 A1, published Sep. 12, 2002, U.S. patent application Ser. No. 10/351,257, filed Jan. 23, 2003, Publication No. US 2003-0219640 A1, published Nov. 27, 2003, U.S. application Ser. No. 10/449,299, filed Feb. 20, 2003, Publication No. US 2003-0208038 A1, published Nov. 6, 2003, each of which are expressly incorporated herein by reference. Other ion-conducting copolymers that can be end capped are made for comonomers such as those used to make sulfonated trifluorostyrenes (U.S. Pat. No. 5,773,480), acid-base polymers, (U.S. Pat. No. 6,300,381), poly arylene ether sulfones (U.S. Patent Publication No. US2002/0091225A1); graft polystyrene (Macromolecules 35:1348 (2002)); polyimides (U.S. Pat. No. 6,586,561 and J. Membr. Sci. 160:127 (1999)) and Japanese Patent Applications Nos. JP2003147076 and JP2003055457, each of which are expressly identified herein by reference.

Another embodiment encompasses a polymer electrolyte membrane comprising the aryl/elastomeric ion conducting copolymer as described herein.

Another embodiment encompasses a catalyst coated membrane comprising the above polymer electrolyte membrane, wherein all or part of at least one of the opposing surfaces of said membrane comprises a catalyst layer.

Another embodiment encompasses a membrane electrode assembly (MEA) comprising the above polymer electrolyte membrane.

Another embodiment encompasses a membrane comprising a polymer electrolyte membrane (PEM) having first and second surfaces, with an adhesion promotion layer in contact with the first and/or second surfaces of the PEM wherein said adhesion promotion layer comprises an aryl/elastomeric ion conducting polymer as set forth in Formula I itself or an ion conducting adhesive composition which includes the aryl/elastomeric ion conducting polymer

Another embodiment encompasses a CCM or MEA having an adhesion promotion layer comprising:

(i) (PEM) having first and second surfaces,

(ii) a first catalyst layer comprising a second ion conducting polymer and a catalyst, wherein said catalyst layer has a first surface, and

(iii) an adhesion promotion layer in contact with the first surface of the PEM and the first surface of the catalytst layer wherein the adhesion promotion layer comprises an aryl/elastomeric ion conducting polymer as set forth in Formula I itself or an ion conducting adhesive composition which includes the aryl/elastomeric ion conducting polymer.

In another particular embodiment, the adhesive composition further comprises inorganic particles.

In another particular embodiment, the inorganic particles are selected from the group consisting of graphitic and amorphous carbon powder, and oxides of silicon, titanium and zirconium.

In another particular embodiment, the inorganic particles have an average diameter between 20 nm and 2000 nm.

In another particular embodiment, the adhesion promotion layer has a thickness between 200 nm and 5000 nm.

In another particular embodiment, the adhesion of said catalyst layer to said PEM via said adhesion promotion layer is greater than the adhesion of said catalyst to said PEM without said adhesion promotion layer.

Another embodiment encompasses a fuel cell comprising the membrane electrode assembly of the invention.

Another embodiment encompasses an electronic device, system, motor, power supply or vehicle comprising the fuel cell of the invention.

The following are some of the monomers used to make the ion-conductive segments in the aryl/elastomeric ion conducting polymer.

1) Difluoro-End Monomers

| | | Molecular | |
|---|---|---|---|
| Acronym | Full name | weight | Chemical structure |
| Bis K | 4,4′-Difluorobenzophenone | 218.20 | 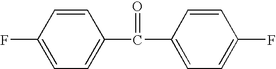 |
| Bis SO₂ | 4,4′-Difluorodiphenylsulfone | 254.25 | 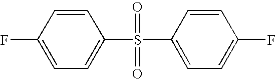 |
| S-Bis K | 3,3′-disulfonated-4,4′- difluorobenzophone | 422.28 | 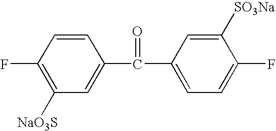 |

2) Dihydroxy-End Monomers

| | | Molecular | |
|---|---|---|---|
| Acronym | Full name | weight | Chemical structure |
| Bis AF (AF or 6F) | 2,2-Bis(4-hydroxyphenyl) hexafluoropropane or 4,4′-(hexafluoroisopropylidene) diphenol | 336.24 | 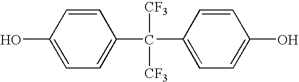 |
| BP | Biphenol | 186.21 | 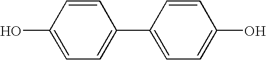 |
| Bis FL | 9,9-Bis(4- hydroxyphenyl)fluorene | 350.41 | 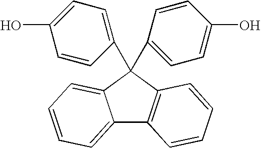 |
| Bis Z | 4,4′-cyclohexylidenebisphenol | 268.36 | 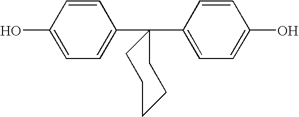 |
| Bis S | 4,4′-thiodiphenol | 218.27 | 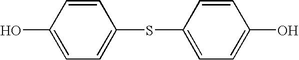 |

3) Dithiol-End Monomers

| | Molecular | |
|---|---|---|
| Full name | weight | Chemical Structure |
| 4,4′-thiol bis benzene thiol | 254.40 | 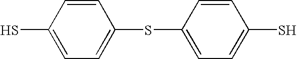 |

Polymer membranes may be fabricated by solution casting of the ion-conductive copolymer. Alternatively, the polymer membrane may be fabricated by solution casting the ion-conducting polymer the blend of the acid and basic polymer.

When cast into a membrane for use in a fuel cell, it is preferred that the membrane thickness be between 0.1 to 10 mils, more preferably between 0.25 and 6 mils, most preferably less than 2.5 mils, and it can be coated over polymer substrate.

As used herein, a membrane is permeable to protons if the proton flux is greater than approximately 0.005 S/cm, more preferably greater than 0.01 S/cm, most preferably greater than 0.02 S/cm.

As used herein, a membrane is substantially impermeable to methanol if the methanol transport across a membrane having a given thickness is less than the transfer of methanol across a Nafion® membrane of the same thickness. In preferred embodiments the permeability of methanol is preferably 50% less than that of a Nafion® membrane, more preferably 75% less and most preferably greater than 80% less as compared to the Nafion® membrane. If the membrane is designed for use in hydrogen fueled fuel cell, this methanol permeability feature is irrelevant.

After the ion-conducting copolymer has been formed into a membrane, it may be used to produce a catalyst coated membrane (CCM). As used herein, a CCM comprises a PEM when at least one side and preferably both of the opposing sides of the PEM are partially or completely coated with catalyst. The catalyst is preferable a layer made of catalyst and ionomer. Preferred catalysts are Pt and Pt—Ru. Preferred ionomers include Nafion® and other ion-conductive polymers. In general, anode and cathode catalysts are applied onto the membrane using well established standard techniques. For direct methanol fuel cells, platinum/ruthenium catalyst is typically used on the anode side while platinum catalyst is applied on the cathode side. For hydrogen/air or hydrogen/oxygen fuel cells platinum is generally applied on the anode and cathode sides. Catalysts may be optionally supported on carbon on either or both sides. The catalyst is initially dispersed in a small amount of water (about 100 mg of catalyst in 1 g of water). To this dispersion a 5% ionomer solution in water/alcohol is added (0.25-0.75 g). The resulting dispersion may be directly painted onto the polymer membrane. Alternatively, isopropanol (1-3 g) is added and the dispersion is directly sprayed onto the membrane. The catalyst may also be applied onto the membrane by decal transfer, as described in the open literature (Electrochimica Acta, 40: 297 (1995)).

The CCM is used to make MEA's. As used herein, an MEA refers to an ion-conducting polymer membrane made from a CCM according to the invention in combination with anode and cathode GDL's positioned to be in electrical contact with the catalyst layer of the CCM. The anode GDL us preferably an anisotropic GDL.

An alternative method to make an MEA is to use gas diffusion material onto which one surface has a coating of catalyst as described above, and such gas diffusion materials are affixed to the membrane with the catalyst coated surface in contact with said membrane on either side to form both a cathode and anode side, thereby creating an MEA.

Electrodes are in electrical contact with the catalyst layer, either directly or indirectly, when they are capable of completing an electrical circuit which includes the MEA and a load to which the fuel cell current is supplied. More particularly, a first catalyst is electrocatalytically associated with the anode side of the PEM so as to facilitate the oxidation of hydrogen or organic fuel. Such oxidation generally results in the formation of protons, electrons and, in the case of organic fuels, carbon dioxide and water. Since the membrane is substantially impermeable to molecular hydrogen and organic fuels such as methanol, as well as carbon dioxide, such components remain on the anodic side of the membrane. Electrons formed from the electrocatalytic reaction are transmitted from the cathode to the load and then to the anode. Balancing this direct electron current is the transfer of an equivalent number of protons across the membrane to the anodic compartment. There an electrocatalytic reduction of oxygen in the presence of the transmitted protons occurs to form water. In one embodiment, air is the source of oxygen. In another embodiment, oxygen-enriched air is used.

The membrane electrode assembly is generally used to divide a fuel cell into anodic and cathodic compartments. In such fuel cell systems, a fuel such as hydrogen gas or an organic fuel such as methanol is added to the anodic compartment while an oxidant such as oxygen or ambient air is allowed to enter the cathodic compartment. Depending upon the particular use of a fuel cell, a number of cells can be combined to achieve appropriate voltage and power output. Such applications include electrical power sources for residential, industrial, commercial power systems and for use in locomotive power such as in automobiles. Other uses to which the invention finds particular use includes the use of fuel cells in portable electronic devices such as cell phones and other telecommunication devices, video and audio consumer electronics equipment, computer laptops, computer notebooks, personal digital assistants and other computing devices, GPS devices and the like. In addition, the fuel cells may be stacked to increase voltage and current capacity for use in high power applications such as industrial and residential sewer services or used to provide locomotion to vehicles. Such fuel cell structures include those disclosed in U.S. Pat. Nos. 6,416,895, 6,413,664, 6,106,964, 5,840,438, 5,773,160, 5,750,281, 5,547,776, 5,527,363, 5,521,018, 5,514,487, 5,482,680, 5,432,021, 5,382,478, 5,300,370, 5,252,410 and 5,230,966.

Such CCM and MEA's are generally useful in fuel cells such as those disclosed in U.S. Pat. Nos. 5,945,231, 5,773,162, 5,992,008, 5,723,229, 6,057,051, 5,976,725, 5,789,093, 4,612,261, 4,407,905, 4,629,664, 4,562,123, 4,789,917, 4,446,210, 4,390,603, 6,110,613, 6,020,083, 5,480,735, 4,851,377, 4,420,544, 5,759,712, 5,807,412, 5,670,266, 5,916,699, 5,693,434, 5,688,613, 5,688,614, each of which is expressly incorporated herein by reference.

The CCM's and MEA's of the invention may also be used in hydrogen fuel cells that are known in the art. Examples include 6,630,259; 6,617,066; 6,602,920; 6,602,627; 6,568,633; 6,544,679; 6,536,551; 6,506,510; 6,497,974, 6,321,145; 6,195,999; 5,984,235; 5,759,712; 5,509,942; and 5,458,989 each of which are expressly incorporated herein by reference.

Polymer membranes may be fabricated by solution casting of the ion conductive copolymer. Alternatively, the polymer membrane may be fabricated by solution casting the ion conducting polymer the blend of the acid and basic polymer.

When cast into a membrane for use in a fuel cell, it is preferred that the 15 membrane thickness be between 0.1 to 10 mils, more preferably between 0.5 and 6 mils, most preferably between 0.75 and 2.5 mils, and it can be coated over polymer substrate.

As used herein, a membrane is permeable to protons if the proton flux is greater than approximately 0.005 S/cm, more preferably greater than 0.01 S/cm, most preferably greater than 0.02 S/cm.

As used herein, a membrane is substantially impermeable to methanol if the methanol transport across a membrane having a given thickness is less than the transfer of methanol across a Nafion® membrane of the same thickness. In preferred embodiments the permeability of methanol is preferably 50% less than that of a Nafion® membrane, more preferably 75% less and most preferably greater than 80% less as compared to the Nafion® membrane.

After the ion conducting copolymer has been formed into a membrane, it may be used to produce a catalyst coated membrane (CCM). As used herein, a CCM comprises a PEM when at least one side and preferably both of the opposing sides of the PEM are partially or completely coated with catalyst. The catalyst is preferable a layer made of catalyst and ionomer. Preferred catalysts are Pt and Pt—Ru. Preferred ionomers include Nafion® and other ion conductive polymers. In general, anode and cathode catalysts are applied onto the membrane by well established standard techniques. For direct methanol fuel cells, platinum/ruthenium catalyst is typically used on the anode side while platinum catalyst is applied on the cathode side. For hydrogen/air or hydrogen/oxygen fuel cells platinum or platinum/ruthenium is generally applied on the anode side, and platinum is applied on the cathode side. Catalysts may be optionally supported on carbon. The catalyst is initially dispersed in a small amount of water (about 100 mg of catalyst in 1 g of water). To this dispersion a 5% ionomer solution in water/alcohol is added (0.25-0.75 g). The resulting dispersion may be directly painted onto the polymer membrane. Alternatively, isopropanol (13 g) is added and the dispersion is directly sprayed onto the membrane. The catalyst may also be applied onto the membrane by decal transfer, as described in the open literature (Electrochimica Acta, 40: 297 (1995)).

The CCM's and MEA's of the invention may also be used in hydrogen fuel cells, which are known in the art.

### Applications of the Block Copolymers of the Invention

The term “ion conducting adhesive composition” refers to a composition comprising the aryl/elastomeric ion conducting polymer of the invention. The ion conducting adhesive composition can also comprise the aryl/elastomeric ion conducting polymer of the invention (a “first ion conducting polymer”) in combination with (1) a second ion conducting polymer; (2) inorganic particles dispersed within the ion conducting polymer; and/or (3) a non-ionomeric polymer. The ion conducting polymer can also contain pores to facilitate adhesion as described herein. In some cases, the second ion conducting polymer is a different aryl/elastomeric ion conducting polymer.

Ion conducting adhesive compositions are generally used when the PEM and catalyst layer contain different ion conducting polymers. In a preferred embodiment, first and second ion conducting polymers are used to make the adhesive polymer composition. These first and second ion conducting polymers can correspond to the ion conducting polymers in the PEM and catalyst layer, respectively or to components within the membrane or catalyst layer. The ion conducting adhesive polymer accordingly has an affinity for both the PEM and the catalyst layer that allows the combination to be used as an adhesive.

However, the first and/or second ion conducting polymers of the adhesive composition need not be the same as the ion conducting polymers of the PEM and catalyst layer. In such cases, the first and second ion conducting polymers are preferably closely related to the ion conducting polymers of the PEM and/or catalyst layer. For example, a first ion conducting polymer is chosen based on the ability to adhere to the surface of the PEM. The second ion conducting polymer is chosen based on its ability to adhere to the catalyst layer.

In another embodiment, the above ion conducting polymers are used in combination with inorganic particles, non-ionomeric polymers and/or pores dispersed therein. When the PEM is not made from Nafion® and the catalyst layer is made from Nafion®, Nafion® may also be used as the ion conducting polymer in an ion conductive adhesive composition, i.e., in combination with inorganic particles, non-ionomeric polymers or pores.

When the ion conducting polymer is mixed with inorganic particles, the non-ionic particle selected should have an average diameter of between 20 nm and 2000 nm. Inorganic particles which may be used include graphitic or amorphous carbon powder or oxides of silicon, titanium and zirconium. The ion-conducting polymer should comprise a sufficient fraction of the mixture to allow proton conductivity through the. The portion of the composition comprising the ion-containing polymer should preferably be 10-95%, more preferably 25-90% and most preferably 50-80%.

When the ion conducting polymer is mixed with a non-ionic polymer, the non-ionic polymer selected should have a melting or glass transition temperature of less than 200° C. Non-ionic polymers which may be used include poly(vinylidene fluoride), copolymers of vinylidene fluoride and hexafluoropropylene, poly(vinyl fluoride), polyethylene, polypropylene, polybutadiene and copolymers of butadiene, acrylonitrile and/or styrene. In a preferred embodiment, the non-ionic polymer used is a copolymer of vinylidene fluoride and hexafluoropropylene. The ion-conducting polymer should comprise a sufficient fraction of the mixture to allow proton conductivity through the layer without hampering the ability of the non-ion conducting polymer to promote adhesion to the catalyst layer. The portion of the composition comprising the ion-containing polymer should preferably be 10-95%, more preferably 25-90% and most preferably 50-80%.

Adhesive compositions containing pores are made by combining an ion conducting polymer with a porogen. This mixture is applied to the surface of a PEM and/or a surface of an electrode (i.e., the surface of the catalyst layer) followed by washing with a solvent that is capable of dissolving the porogen but not the ion conducting polymer. After drying, the adhesive coated PEM and/or adhesive coated electrode are placed in proximity to each other to form an adhesive layer between the surface of the catalyst layer and the surface of the PEM. The ion conducting polymer of the catalyst layer preferably fills the pores of the adhesive composition. The ion conducting polymer of the PEM may also enter the pores of the adhesive layer depending upon its ability to flow into the pores under the conditions for forming MEA.

Any of the ion conducting polymers used to make a PEM may also be used as ionomers in the catalyst layer. However, a preferred ionomer for use in forming the catalyst layer is Nafion®.

The electrodes used to form the MEAs of the invention preferably comprise a catalyst layer and a gas diffusion layer. The catalyst layer comprises a catalyst (e.g., platinum or platinum/ruthenium particles or catalyst particles supported on carbon particle) and an ionomer such as Nafion®. The gas diffusion layer (GDL) may comprise carbon paper or cloth, for example, Toray paper and the like. First, electrodes comprising the GDL and first catalyst layer can be used in combination with the ion conductive adhesive composition and the first surface of the PEM to form the MEA.

The MEA may further comprise a second adhesion promotion layer between a second surface of the PEM and a second catalyst layer. The ion conductive adhesive composition may comprise a third ion conducting polymer in combination with (1) a fourth ion conducting polymer; (2) inorganic particles dispersed within the ion conducting polymer; and/or (3) a non-ionomeric polymer. It may also contain pores formed within the ion conducting polymer. The third and fourth ion conducting polymers may be the same as the first and second ion conducting polymers used above to form the first adhesive layer or may be different. If the catalyst layers are made from the same ion conducting polymer, it is preferred that the third and fourth ion conducting polymers correspond to the first and second ion conducting polymers.

In an alternate embodiment, a gas diffusion layer may be laid down on a decal. A catalyst may then be layered on the exposed surface of the GDL. The decal containing the electrode can be used according to the disclosure of the invention to form the MEA containing an ion conductive adhesive layer between the PEM and the catalyst layer present on the decal.

### EXAMPLES

### Example 1

### Synthesis of an Acyl Chloride-Terminated Elastomeric Oligomer

“Carboxy-terminated butadiene oligomer” of 4000 molecular weight (12.0 g, 0.0030 mol) is dissolved in toluene (100 g). To the mixture is added PCl₅ (1.70 g, 0.0082 mol) and the mixture is stirred at 80 C for 2 hours. The toluene is removed by evaporation and the recovered “acyl chloride-terminated butadiene oligomer” is washed with water and then dried at 80 C under vacuum.

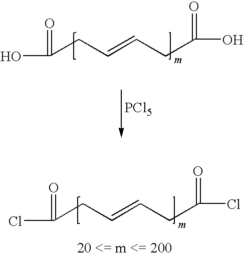

### Example 2

### Synthesis of an Amino-Terminated Sulfonated Oligomer

In a separate reaction mixture, 4,4′-difluorobenzophenone (11.055 g, 0.0507 mol), 4,4′-difluorobenzophenone 3,3′-disodium sulfonate (9.169 g, 0.0217 mol) and cyclohexylidene bisphenol (18.452 g, 0.0688 mol) are dissolved in 200 g DMSO and 10 g toluene with potassium carbonate (10.929 g, 0.0361 mol). There is molar excess of the difluoro vs dihydroxy monomers. The reaction mixture is heated in a Dean-Stark trap under nitrogen flow from 120 C-170 C over 8 hours and then cooled, producing a “fluoro-terminated sulfonated oligomer” intermediate. To the reaction mixture is added 4-aminophenol (0.80 g, 0.0073 mol) and an additional 100 g Toluene. The. The reaction mixture is heated in a Dean-Stark trap under nitrogen flow from 120 C-170 C over 8 hours and then cooled, precipitated in water and washed several times with methanol and water before being dried at 80 C under vacuum, producing the “amino-terminated sulfonated oligomer.”

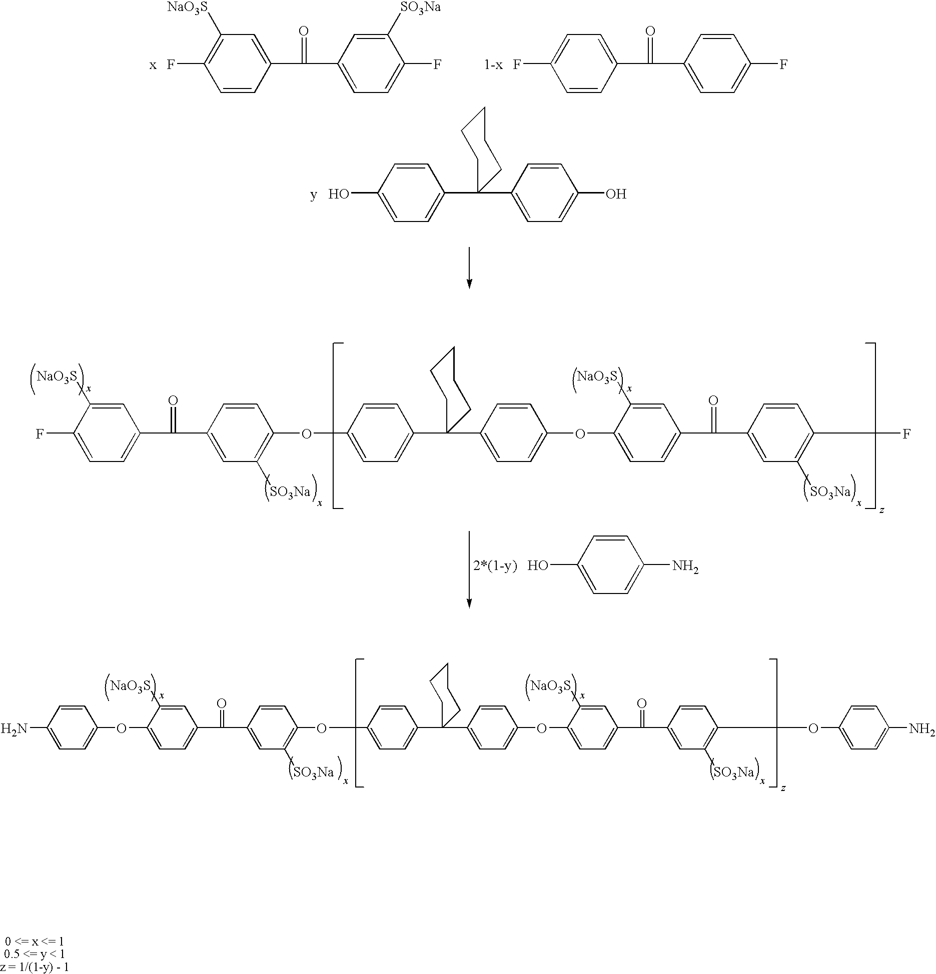

### Example 3

### Synthesis of Multiblock Copolymer

The “acyl chloride-terminated butadiene oligomer” (13.82 g, 0.00137 mol) produced in Example 1 and the amino-terminated sulfonated oligomer (5.52 g, 0.00137 mol) produced in Example 2 are dissolved in 20 g toluene and 50 g N,N-dimethylformamide and stirred under nitrogen at 170° C. for 16 hours to produce the multiblock copolymer 1.

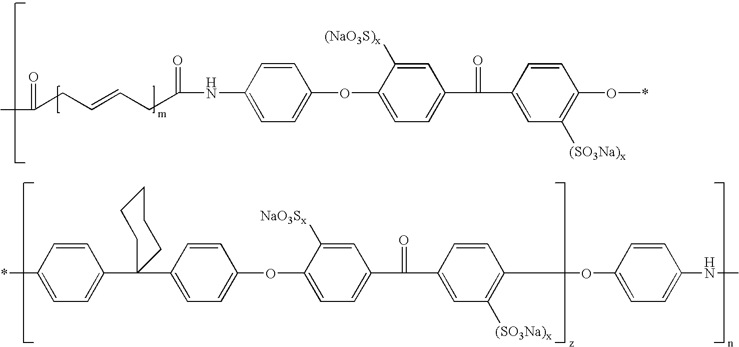

| Polymer | m | x | y | z |
|---|---|---|---|---|
| 1 | −78 | 0.3 | 0.95 | 19 |
| 2 | −78 | 0.3 | 0.975 | 39 |

### Example 4

### Use as an Adhesion Promotion Layer

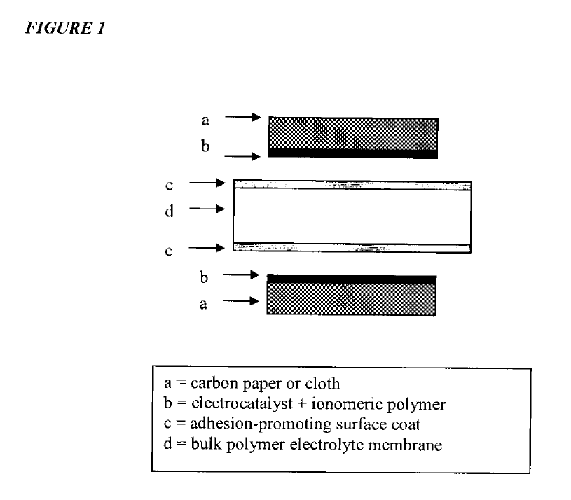

Polymer is dissolved in N,N-dimethylacetamide to produce a 5% by weight solution. It is coated onto a film of PolyFuel DM-1 membrane by a rod-coating process using a standard #6 rod to produce a membrane containing an adhesion promotion layer as illustrated in FIG. 1.

### Example 5

A 5% solution of Nafion® PFSA ionomer in DMAc solvent (9.5 g) is added to a vial which contains graphitized carbon particles (0.158 g) such that the weight ratio of solid Nafion® to solid graphitized carbon is 3:1. Additional DMAc solvent (3.0 g) is added such that the final % solids of the slurry is 5% by weight. The slurry is sonicated with a probe sonicator for 10 minutes to form ion conducting adhesive. A polymer electrolyte membrane based on a sulfonated poly(arylene ether ketone) is dried in a 100° C. oven for 15 minutes. The ion conducting adhesive is applied to each side of this membrane slurry using a #6 rod-coater. The adhesive is dried under forced air at room temperature and then in an oven at 100° C. for 45 minutes. The resultant adhesive-coated membrane is annealed in a hotpress at 140° C. for 2 minutes under about 10 kg/cm2.

### Example 6

A 5% solution of Nafion® PFSA ionomer in DMAc solvent (2.0 g) is mixed with a 5% solution of a sulfonated poly(arylene ether ketone) in DMAc (2.0 g). The mixture is agitated for a few moments. The mixture is sonicated with a probe sonicator for 10 minutes to form an ion conducting adhesive composition. A polymer electrolyte membrane based on a sulfonated poly(arylene ether ketone) is dried in a 100° C. oven for 15 minutes. The ion conducting composition is applied to each side of this membrane using a #6 rod-coater. The adhesive is dried under forced air at room temperature and then in an oven at 100° C. for 45 minutes. The resultant adhesive-coated membrane is annealed in a hotpress at 140° C. for 2 minutes under about 10 kg/cm².

### Example 7

A 5% solution of a sulfonated poly(arylene ether ketone) in DMAc (3.0 g) is mixed with a 5% solution of poly(vinylidene fluoride-co-hexafluoropropylene) in DMAc (1.0 g). The mixture is agitated for a few moments to form an ion conducting adhesive composition. The mixture is sonicated with a probe sonicator for 10 minutes. A polymer electrolyte membrane based on a sulfonated poly(arylene ether ketone) is dried in a 100° C. oven for 15 minutes. The ion conducting adhesive composition is applied to each side of this membrane using a #6 rod-coater. The adhesive is dried under forced air at room temperature and then in an oven at 100° C. for 45 minutes.

### Example 8

The surface coated membrane from Example 5, 6 or 7 is soaked in water at 60° C. for 16 hours. It is removed from the water and is blotted dry. An anode (PtRu electrocatalyst+Nafion® ionomer on a GDL carbon paper) and a cathode (Pt electro catalyst+Nafion® ionomer on a GDL carbon paper) are placed on either side of the membrane. The Anode/Membrane/Cathode laminate is pressed at 150° C. for 3 minutes at 80 kg/cm2.

The present invention is not to be limited in scope by the specific embodiments disclosed in the examples which are intended as illustrations of a few aspects of the invention and any embodiments which are functionally equivalent are within the scope of this invention. Indeed, various modifications of the invention in addition to those shown and described herein will become apparent to those skilled in the art and are intended to fall within the appended claims.

A number of references have been cited, the entire disclosures of which are incorporated herein by reference.

What is claimed is:

1. An ion conducting copolymer comprising at least one ion conducting arylene segment comprising an ion conducting group and at least one non-ion conducting elastomeric segment.

2. An ion conducting polymer represented by formula I:
-[(E)ₑ-L₁-ICS-L₂-]ₖ-
where (E)ₑ is an elastomeric segment, E is an elastomeric unit, e is the number of elastomeric units in the elastomeric segment, L₁ is a bond or a linking group, ICS is an ion conducting arylene segment, L₂ is a bond or a linking group which can be the same or different than L₁, and k is the number of times the unit is repeated.

3. The ion conducting copolymer of claim 2, wherein ISC is represented by Formula II:
[[(Ar₁-T-)ᵢ—Ar₁—X—]ₐ^{m}[Ar₂—U—Ar₂—X—]_{b}ⁿ[(Ar₃—V—)ⱼ—Ar₃—X—]_{c}^{o}[Ar₄—W—Ar₄—X—]_{d}^{p}] Formula II
wherein
Ar₁, Ar₂, Ar₃ and Ar₄ are aromatic moieties and at least one of Ar₁ or Ar₂ comprises an ion conducting group;
wherein:
T, U, V and W are linking moieties;
X are independently —O— or —S—;
i and j are independently integers equal to or greater than 1;
a, b, c, and d are mole fractions wherein the sum of a, b, c and d is 1, and a and/or b is greater than zero; and
m, n, o, and p are integers indicating the number of different oligomers or monomers in the copolymer.

4. The ion conducting copolymer of claim 3, wherein the ion conducting group comprises a sulfonic acid.

5. The ion conducting copolymer of claim 3, wherein at least one of Ar₁, Ar₂, Ar₃ and Ar₄ comprises a benzophenone monomer.

6. The ion conducting copolymer of claim 3, wherein at least one of Ar₁, Ar₂, Ar₃ and Ar₄ comprises a cyclohexylidene bisphenol monomer.

7. The ion conducting copolymer of claim 5, wherein at least one benzophenone monomer comprises an ion conducting group.

8. The ion conducting copolymer of claim 7, wherein at least one benzophenone monomer comprises a sulfonic acid.

9. The ion-conducting copolymer of claim 1, wherein the elastomeric segment comprises butadiene, isoprene, styrene, acrylonitrile, ethylene monomers and mixtures thereof.

10. The ion-conducting copolymer of claim 9, wherein the elastomeric segment comprises a styrene/butadiene/styrene block copolymer (SBS), styrene/isoprene block/styrene block copolymer (SIS), random styrene/butadiene copolymers (random SBR), tapered SBR, microblock SBR, random styrene/isoprene copolymer (random SIR), tapered SIR, random styrene/butadiene/isoprene (random SIBR), styrene-ethylene/butylene-styrene block copolymer (SEBS), styrene-ethylene/butylene block copolymer (SEB), styrene-ethylene/propylene-block copolymer (SEP), styrene-ethylene/propylene-styrene block copolymer (SEPS), styrene-ethylene/propylene-ethylene block copolymer (SEPE), styrene-ethylene/butylene-ethylene block copolymer (SEBE), styrene-ethylene/styrene block copolymer (SES), ethylene-ethylene/butylene block copolymer (EEB), ethylene-ethylene/butylene/styrene block copolymer (hydrogenated BR-SBR block copolymer), ethylene-ethylene/butylene/styrene-ethylene block copolymer (hydrogenated BR-SBR-BR block copolymer), ethylene-ethylene/butylene-ethylene block copolymer (EEBE) and partially or fully hydrogenated versions of these polymers and copolymers.

11. The ion-conducting copolymer of claim 1, wherein said elastomeric segment comprises a butadiene monomer.

12. An ion conducting polymer of formula: 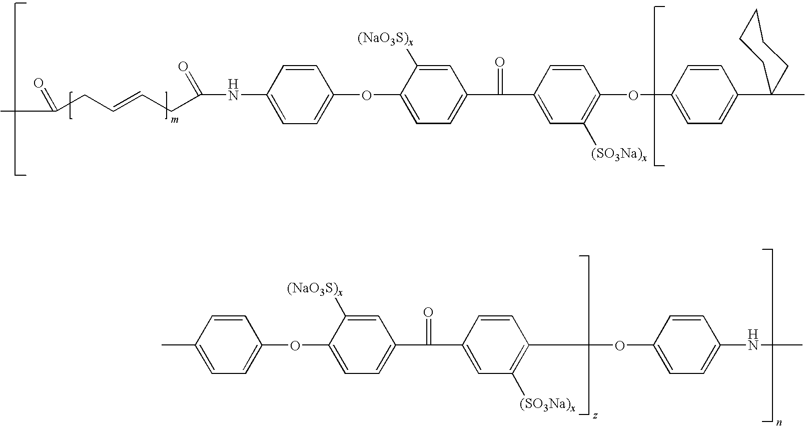
wherein
m is from about 10 to about 500;
x is the mole fraction of monomer containing sulfonic acid moieties;
z is from about 1 to about 100; and
n is from about 2 to about 500.

13. The ion-conducting copolymer of claim 12, wherein m is from about 20 to about 200.

14. The ion-conducting copolymer of claim 12, wherein m is from about 50 to about 100.

15. The ion-conducting copolymer of claim 12, wherein m is about 70 to about 80.

16. The ion-conducting copolymer of claim 12, wherein x is 0.3 or greater.

17. The ion-conducting copolymer of claim 12, wherein x is 1.

18. The ion-conducting copolymer of claim 12, wherein z is from about 1 to about 100.

19. The ion-conducting copolymer of claim 12, wherein z is from about 15 to about 50.

20. The ion-conducting copolymer of claim 12, wherein z is about 19 to about 40.

21. A polymer electrolyte membrane comprising the ion conducting copolymer of claim 1.

22. An ion conducting membrane comprising a polymer electrolyte membrane (PEM) having first and second surfaces and an adhesion promotion layer in contact with said first and/or said second surfaces of the PEM wherein said adhesion promotion layer comprises the ion conducting polymer of claim 1

23. A catalyst coated membrane comprising the polymer electrolyte membrane of claim 21 or 22, wherein all or part of at least one of the opposing surfaces of said membrane comprises a catalyst layer.

24. A membrane electrode assembly (MEA) comprising the polymer electrolyte membrane of claim 21 or 22.

25. A membrane electrode assembly (MEA) comprising:
(a) a polymer electrolyte membrane (PEM) comprising a first ion conducting polymer and having first and second surfaces;
(b) a first catalyst layer comprising a second ion conducting polymer and a catalyst, wherein said catalyst layer has a first surface, and
(c) an adhesion promotion layer in contact with said first surface of said PEM and said first surface of said catalyst layer, wherein said adhesion promotion layer comprises an ion conducting adhesive copolymer comprising the ion conducting copolymer of claim 1.

26. The MEA of claim 25 wherein at least one of said first or said second ion conducting polymers comprises a polyarylene segment, wherein the polyarylene segment of said ion conducting adhesive copolymer comprises said polyarylene segment of said first or said second ion conducting polymers.

27. The MEA of claim 26, wherein said adhesive composition further comprises inorganic particles.

28. The MEA of claim 27, wherein said inorganic particles are selected from the group consisting of graphitic and amorphous carbon powder, and oxides of silicon, titanium and zirconium.

29. The MEA of claim 26, wherein said inorganic particles have an average diameter between 20 nm and 2000 nm.

30. The MEA of claim 25 wherein said adhesion promotion layer has a thickness between 200 nm and 5000 nm.

31. The MEA of claim 25 wherein the adhesion of said catalyst layer to said PEM via said adhesion promotion layer is greater that the adhesion of said electrode to said PEM without said adhesion promotion layer.

32. A fuel cell comprising the membrane electrode assembly of claim 24 or 25.

33. An electronic device, system, motor, power supply or vehicle comprising the fuel cell of claim 32.
